(19) United States
(12) Patent Application Publication
(10) Pub. No.: US 2010/0321708 A1
(43) Pub. Date: Dec. 23, 2010

(54) PRINTING OF CODING PATTERNS

(76) Inventor: Stefan Lynggaard, Lund (SE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/446,029

(22) PCT Filed: Oct. 17, 2007
(86) PCT No.: PCT/SE07/00917

§ 371 Date: Apr. 17, 2009

Related U.S. Application Data
(60) Provisional application No. 60/862,375, filed on Oct. 20, 2006.

(30) Foreign Application Priority Data
Oct. 20, 2006 (SE) 0602215-6

(51) Int. Cl. H04N 1/60

(52) U.S. Cl. 358/1.9

(57) ABSTRACT

A method is designed for printing on regular digital printers of a coding pattern consisting of code symbols. In the method, a character-based representation of the coding pattern is obtained, wherein the code symbols are represented by characters according to a character definition set. A definition identifier is generated to identify the character definition set. The definition identifier is specific to the morphology of the coding pattern or to the printing job. Finally, a print module is caused to print the coding pattern based on the character-based representation, the character definition set and the definition identifier.

### CROSS-REFERENCE TO RELATED APPLICATIONS

The present application claims the benefit of Swedish patent application No. 0602215-6, filed on Oct. 20, 2006, and U.S. provisional patent application No. 60/862,375, filed on Oct. 20, 2006, both of which being hereby incorporated by reference.

### FIELD OF THE INVENTION

The present invention generally relates to printing of coding patterns on on-demand digital printers.

### BACKGROUND ART

It is known to use a coding pattern to embed some type of information in a passive base such as a sheet of paper, a writing board or equivalent. A suitably programmed scanner, fax machine, camera or digital pen can then read, recreate and use the information embedded locally in the base. For example, graphical information on a base can be supplemented with embedded information which extends the functionality of the base. Such embedded information can comprise file data for full or partial recreation of the graphical information, commands, supplementary text or images, hyperlinks, absolute positions, etc.

Coding patterns are generally constructed around some form of machine-readable code symbols which are regularly spaced on the base. Examples of such coding patterns are given in U.S. Pat. No. 5,221,833; U.S. Pat. No. 5,477,012; WO 00/73983; WO 01/26032; WO 01/71643; and U.S. Pat. No. 6,330,976.

In many cases, bases with a coding pattern can be generated on a large scale and with high precision in the graphics industry. There are, however, also occasions when it is desirable to create bases with a coding pattern on a small scale. This can then be carried out using a personal computer, to which a digital printer of, for example, the ink-jet or laser type, has been connected.

This can be carried out in such a way that the required coding pattern is created as an image file in a graphical format, for example, in bitmap format. This image file is converted into a page-describing and normally printer-independent code, such as PostScript (trademark), after which it is transmitted to the printer unit. On the basis of the page-describing code, the printer unit creates corresponding instructions for control of the printer's hardware. This hardware can, in the case of a laser printer, comprise a laser diode with associated optics. In an ink-jet printer, the hardware may comprise an ink ejector. The printing is then carried out on a base, for example a sheet of paper.

If the coding pattern has a high information density, which can be achieved by high information content in each code symbol and/or by dense arrangement of the code symbols on the base, the image file and the page-describing code may become large. Consequently, transfer times and printer processing times for such code may become excessive.

WO 02/082366 proposes a technique to reduce the size of the page-describing code, specifically for a coding pattern that codes a continuous sequence of absolute positions in two dimensions. Here, the printer unit is integrated with a pattern generation module, which is implemented by software and/or hardware to generate the coding pattern based on information describing the boundaries of the absolute positions to be coded on the base. Thus, the page-describing code can be supplemented by such boundary information to represent the coding pattern. This approach provides for significant reduction in both transfer time and printer processing time.

However, it may be difficult or even impossible to upgrade existing printers with the necessary pattern generation module. This may cause a technological barrier to the introduction and adoption of coding patterns on passive bases, since a large number of prospective users must invest in new printers.

According to WO 2004/104818, it is possible to reduce the size of the page-describing code and the printer processing times by using a character definition set, e.g. a font, to represent a set of mutually unique groups of said code symbols. The font representation is compact and results in a significant reduction in the number of code instructions compared to generation of bitmaps of each code symbol. Further, digital printers are generally optimized for handling fonts, and often have a dedicated cache memory for font definitions.

In WO 2005/124524, a printer is shown having one or more font definition files stored in memory. When a coding pattern is to be printed, metadata is transmitted in the document file to instruct the printer to retrieve from memory the font definition file corresponding to the meta-data. However, this requires that the font definition file is predefined and stored in the printer. This may not be suitable for printing coding patterns. The coding pattern may be changed in a vast number of ways that would affect the graphical representation of groups of code symbols. These changes may be printer-specific in order to adapt the coding pattern to the printer characteristics. Also, changes may need to be made during use of the same printer due to e.g. wear of parts of the printer or changes in ink supply. In order to handle all these variations of the coding pattern, a great amount of different font definitions would be needed. Thus, printing of a coding pattern according to the technique suggested in WO 2005/124524 requires development of an impractical amount of different font definitions.

Another approach is to create a font definition when a coding pattern is to be printed. This implies that the font definition is sent to the printer each time a coding pattern is to be printed to be stored in a cache memory of the printer. Further, instructions are sent to the printer to set the font definition as the current font, whereby the font may be accessed in the cache memory. However, when creating a multi-page document with coding pattern, it is often preferred to define the font at the start of each page in order to allow single pages in the document to be easily accessed and printed. This implies that when a large document is printed, a multitude of font definitions will be sent to the printer and stored in the cache memory. Thus, the cache memory of the printer may quickly be filled. When this occurs a new font definition may not be stored, and the printer may no longer benefit from using a font to reduce the number of code instructions compared to generation of bitmaps of each code symbol.

### SUMMARY OF THE INVENTION

An object of the present invention is to provide an improved technique for printing coding patterns using character definition sets.

These and other objects that will be evident from the following description are now achieved wholly or partly by methods, systems and computer program products according to independent claims 1, 22, 23, 24, 28 and 29. Preferred embodiments are defined in the dependent claims.

A first aspect of the invention is a method in printing a coding pattern consisting of code symbols, comprising: obtaining a character-based representation of the coding pattern, in which the code symbols are represented by characters according to a character definition set; generating a definition identifier which identifies the character definition set and is specific to the morphology of the coding pattern to be printed; and causing a print module to print said coding pattern based on said character-based representation, said character definition set, and said definition identifier, wherein said generating is performed in connection to printing of the coding pattern.

According to the first aspect of the invention, a definition identifier is generated in connection to printing of the coding pattern. This implies that a definition identifier is obtained even though the character definition set may not be created in beforehand and delivered with an identifier. Since the identifier is specific to the morphology of the coding pattern, the same identifier may be generated at different occasions for the same morphology of the coding pattern, i.e. when the same character definition set may be used. Therefore, if the same character definition set is used a second time on the same printer, the character definition set may be retrieved from cache memory of the printer since it has been assigned the same definition identifier as the first time. This implies that the same character definition set will not be stored twice in cache memory of the printer, whereby the risk of filling the cache memory is greatly reduced. Further, there is no need of distributing a vast amount of character definition sets with predefined identifiers. Instead, all character definition sets and definition identifiers will be created when a specific morphology of a coding pattern is to be printed and the morphology is defined.

As used herein, the term “morphology of a coding pattern” should be construed as a definition that controls the graphical representation of the components forming the coding pattern. Thus, the morphology may for example define the shape, size and relative placement of code marks forming the coding pattern.

Further, the feature that generation of the definition identifier is performed in connection to printing of the coding pattern does not imply that the definition identifier must be generated at the specific time a printing job is transferred to the printer. However, the generation of a definition identifier is controlled locally where a decision to print a coding pattern is taken. Thus, the definition identifier is not created until the need of using the character definition set is discovered. The definition identifier may be generated at a first point of time when the decision to print the coding pattern is taken and a page-describing file may be created. However, the page-describing file may be transferred to a printer at a much later stage for actual printing.

A second aspect of the invention is a computer program product, directly loadable into the internal memory of a processor in a computer unit, comprising software instructions that, when executed in said processor, perform the method of the first aspect.

A third aspect of the invention is a system for printing a coding pattern consisting of code symbols, comprising: means for obtaining a character-based representation of the coding pattern, in which the code symbols are represented by characters according to a character definition set; means for generating a definition identifier which identifies the character definition set and is specific to the morphology of the coding pattern to be printed; and means for causing a print module to print said coding pattern based on said character-based representation, said character definition set, and said definition identifier.

A fourth aspect of the invention is a method in printing a coding pattern consisting of code symbols, comprising: obtaining a character-based representation of the coding pattern, in which the code symbols are represented by characters according to a character definition set; generating a definition identifier which identifies the character definition set and is specific to the printing job to be made; and causing a print module to print said coding pattern based on said character-based representation, said character definition set, and said definition identifier.

According to the fourth aspect of the invention, a definition identifier is generated in connection to printing of the coding pattern. This implies that a definition identifier is obtained even though the character definition set may not be created in beforehand and delivered with an identifier. Therefore, a printer will be able to access the character definition set in the cache memory throughout a printing job. This eliminates the risk of filling the cache memory of a printer during printing of a job comprising a large number of pages. Further, there is no need of distributing a vast amount of character definition sets with predefined identifiers.

As used herein, the term “printing job” should be construed as one task for a printer to output a hardcopy of a digital document that may comprise one or more pages.

A fifth aspect of the invention is a computer program product, directly loadable into the internal memory of a processor in a computer unit, comprising software instructions that, when executed in said processor, perform the method of the fourth aspect.

A sixth aspect of the invention is a system for printing a coding pattern consisting of code symbols, comprising: means for obtaining a character-based representation of the coding pattern, in which the code symbols are represented by characters according to a character definition set; means for generating a definition identifier which identifies the character definition set and is specific to the printing job to be made; and means for causing a print module to print said coding pattern based on said character-based representation, said character definition set, and said definition identifier.

### BRIEF DESCRIPTION OF THE DRAWINGS

The invention will now be described by way of example with reference to the accompanying drawings, which schematically illustrate currently preferred embodiments.

FIG. 1 is a schematic illustration of a system for printing a coding pattern.

FIG. 2 is a view showing a prior art coding pattern.

FIG. 3A is a schematic illustration of a font definition for the pattern of FIG. 2.

FIG. 3B is a view of a symbol definition for the pattern of FIG. 2.

FIG. 3C is a schematic illustration of a page-describing code for the pattern in FIG. 2, based on the font definition in FIG. 3A.

FIG. 3D is a schematic illustration of a page-describing code generated in an alternative embodiment.

FIG. 4A is a schematic illustration of a font definition stored in a printer.

FIG. 4B is a schematic illustration of contents of a page-describing file.

FIG. 5 is an example of an identifier of a font definition.

FIG. 6A is a schematic view of a system implementing a printing method according to the invention.

FIG. 6B is a schematic view of a base with an information layer and a coding layer.

FIG. 6C is a flow chart of a printing method according to the invention.

FIG. 7 is a schematic block diagram of an electronic circuitry part in the printer shown in FIG. 6A.

### DETAILED DESCRIPTION OF PREFERRED EMBODIMENTS

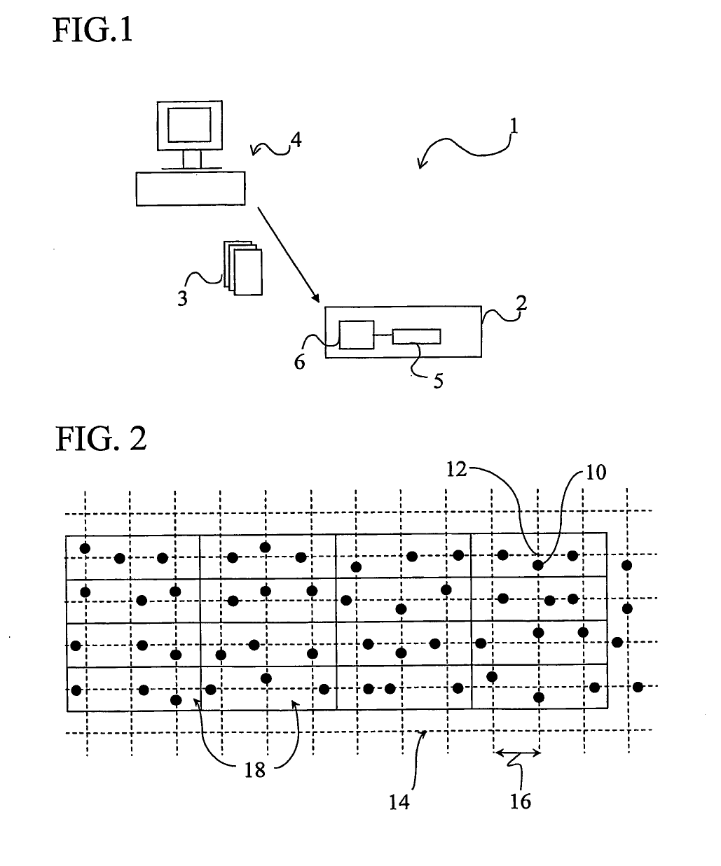

Referring to FIG. 1, a system 1 for printing a coding pattern consisting of code symbols will be generally described. The system 1 comprises a printer 2 that will generate pages with printed coding pattern. The printer 2 receives instructions of a printing job 3 and based on these instructions generates image data to a print engine controller for printing the pages of the printing job. The printing job 3 may be sent from a computer 4 directly connected to the printer 2 or connected to the printer 2 via a network.

A character definition set may be used to define image data of mutually unique groups of code symbols and/or individual code symbols. This implies that the printer 2 may only need to create the image data of each character in the character definition set once. The character definition set may thereafter be stored in a cache memory 5 of the printer 2, such that the image data may be directly obtained from the memory, whereby processing speed of the printer is increased. The character definition set is stored in the cache memory 5 with a definition identifier that enables the printer 2 to access and reuse the character definition set.

However, the graphical representation of components of a coding pattern may need to be varied in a vast number of different ways in order for a printer 2 to correctly generate pages with printed coding pattern. For example, the size of a code symbol and spacing between code symbols may need to be customized to the type of printer 2 that is to generate pages with printed coding pattern. It should be realized that the coding pattern may need to be very accurately printed in order to be correctly decoded. Thus, the size of code symbols and the spacing between code symbols may need to be finely adjusted in order for the coding pattern to be correctly printed. Further, the wear of the printer 2 and the toner level of the printer 2 and other printer parameters may also affect the printing of the coding pattern and may therefore require different graphical representations of the components of the coding pattern to be used with the same printer 2. Since a character definition set defines image data of components of a coding pattern, the same character definition set may not be used for two different variations of the coding pattern. In order to avoid creating enormous number of different character definition sets in advance, the character definition set and its identifier are created when needed.

The printer 2 may receive instructions of a printing job 3 containing a page-describing code and parameters describing the components of the coding pattern. Based on these parameters, a processing unit 6 of the printer 2 may create the character definition set and the identifier and store it in the cache memory 5. Alternatively, the character definition set and the identifier are created in a computer 4 and sent to the printer 2 with the page-describing code of the printing job 3. According to a further alternative, the character definition set is created in the computer 4 and the identifier is generated in the printer 2 in connection to storing the character definition set in the cache memory 5.

The identifier is generated in a structured way such that it may be found in the cache memory 5. According to one embodiment, the identifier is based on the parameters describing the components of the coding pattern. When an identical type of coding pattern is later used, the same identifier is generated and the stored character definition set may be found in the cache memory 5. According to another embodiment, the identifier is specific for the printing job 3 to be made. This implies that the character definition set may be found in cache and used for printing of every page within the printing job 3.

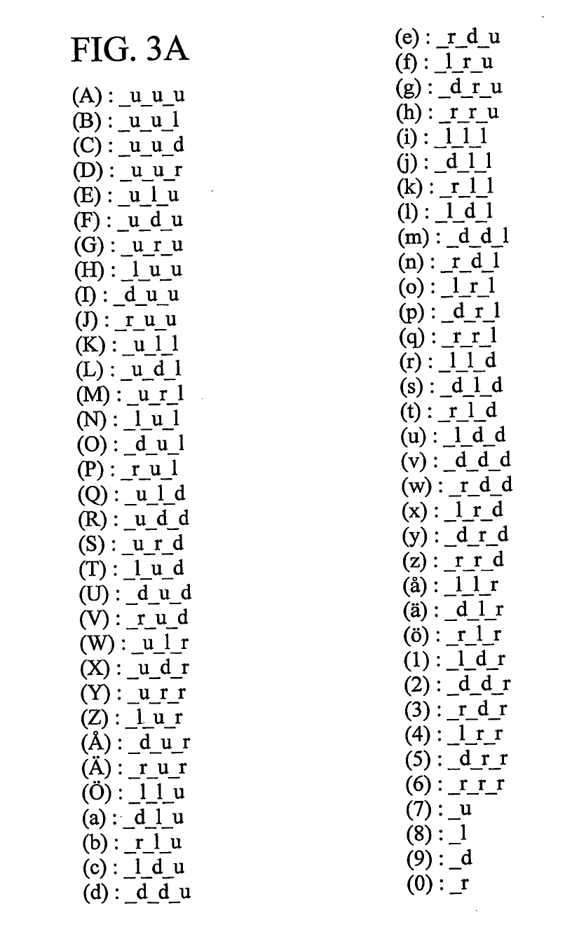

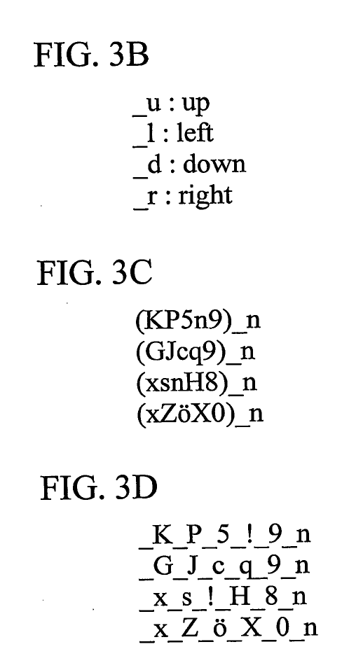

In order to describe the invention in more detail, a description of an example of a coding pattern will first be given with reference to FIG. 2 and a description of an example of a character definition set suited for describing the coding pattern will then be given with reference to FIGS. 3A-3B.

FIG. 2 illustrates a part of an absolute position-coding pattern, which will be used to exemplify the invention. The position-coding pattern is detailed in Applicant's International Patent Publication No. WO 01/26032, which is incorporated herein by this reference. Principally, the coding pattern of FIG. 2 is made up of simple graphical symbols, which can assume four different values and thus are capable of coding two bits of information. Each symbol consists of a mark 10 and a spatial reference point or nominal position 12, the mark 10 being displaced or offset a distance in one of four different directions from the nominal position 12. The value of each symbol is given by the direction of displacement. The symbols are arranged with the nominal positions 12 forming a regular raster or grid 14 which may be virtual and thus not explicitly included in the coding pattern. Thus, the symbols can be regarded as being regularly spaced, as they are arranged regularly in a two-dimensional symbol space which is defined by the grid.

Each absolute position is coded by the collective values of a group of symbols within a coding window, e.g. containing 6×6 adjacent symbols. Further, the coding is “floating”, in the sense that an adjacent position is coded by a coding window displaced by one grid spacing. In other words, each symbol contributes in the coding of several positions.

The coding pattern of FIG. 2 may be used to code both positions and other data, or only other data than positions, as disclosed in Applicant's International Patent Publication No. WO 01/71653.

The coding pattern of FIG. 2 can be reproduced on a base with high information density. The grid spacing (as indicated by 16 in FIG. 2) may typically be 0.3 mm, which translates to more than 400,000 symbols on a 25 cm high by 15 cm wide page. Evidently, it might be difficult to print such a high-density coding pattern on a regular digital printer at a reasonable speed.

In order to increase printing speed, it is suitable to use a character definition set to represent the coding pattern. The use of a character definition set is described in WO 2004/104818, which is hereby incorporated by reference. However, in order to facilitate understanding of the present invention, the concept of using a character definition set is also described below.

The character definition set will be exemplified below as a font definition. However, it is possible to define the character definition set in other ways as will be exemplified with reference to FIG. 3D.

Characters of the font definition will define a graphical representation of mutually unique symbols or groups of symbols. This implies that the coding pattern may be defined as a sequence of characters of the font definition. Thus, the coding pattern is defined in a more compact way.

Each character in the font definition may comprise instructions to a printer for forming the graphical representation of the one or more symbols of the coding pattern. In this way, image data of the one or more symbols may be created. Further, this image data may be stored such that the printer may reuse it, which will significantly increase printing speed.

The font will be stored in a cache memory of the printer, whereby the image data of the coding pattern need not be separately created for each of the 400,000 symbols.

In the following, examples of how fonts may be constructed to represent the coding pattern will be given. The following examples assume that a page-describing code is text-based and written in the widely adopted PostScript (trademark) programming language, although other types of formats and programming languages are certainly conceivable, for example PCL (Printer Control Language).

A first example of such a font is given in FIG. 3A. Each character in the font represents a unique group of code symbols, here a row segment of three consecutive symbols. Thus, each such group has a size of 1×3 in symbol space (number of symbol rows, number of symbol columns).

As noted above, the coding pattern of FIG. 2 is based on four different coding symbols. In PostScript code, each symbol can be represented by a function/program call in the form of blank space (illustrated as “_” in the drawings) and a unique function/program name, as indicated in FIG. 3B. The corresponding function/program (not shown) comprises PostScript instructions to move a pointer from a starting location to a given printing location, to generate a circular dot of given size at the printing location, and to reset the printing location to a new starting location.

For example, font character (A) is defined to consist of a first dot which is displaced a given distance upwardly from a first nominal position, a second dot which is displaced a given distance upwardly from a second nominal position, and a third dot which is displaced a given distance upwardly from a third nominal position. The PostScript language is a text-based programming language based on the ASCII format. Thus, 128 unique characters are available in a font to represent symbol groups, less any characters that are predefined for basic function/program calls, such as “%”, “/”, “(“,”)”, etc. The unique 1×3 symbol groups in FIG. 3A can be represented by 64 characters. The font of FIG. 3A may be defined either as a bitmap font or an outline font. In a bitmap font, each character (i.e. each 1×3 symbol group) is represented as a fixed-size pixel image. In an outline font, each character is scaleable in size and represented by a mathematical expression.

In creating the page-describing code, the digital representation of the coding pattern is parsed in symbol space, in this example row by row, to thereby divide the coding pattern into symbol groups, each such group being represented by a font character in the page-describing code. For illustrative purposes, these symbol groups are indicated by boxes 18 in FIG. 2.

FIG. 3C is a schematic version of the page-describing code of the coding pattern in FIG. 2, based on the font definition in FIG. 3A. The actual page-describing file will also i.a. include page-describing code for any graphical data to be printed together with the coding pattern.

Returning to FIG. 3A, it should be noted that the font definition also includes font characters (7, 8, 9, 0) that represent the unique individual symbols. This is done to handle a symbol residue that results from a potential mismatch of the group size and the coding pattern size in the symbol space. Such mismatch occurs when the coding pattern size and the group size are relatively prime in one or both dimensions of the symbol space. In the example of FIG. 2, there are 13 symbols in each row of the coding pattern. Evidently, all symbols cannot be divided into groups of three symbols. One symbol on each row is therefore represented by a single symbol character. In a more advanced scenario, the font definition may include other symbol groups, for example 1×2 symbol groups, to handle this problem.

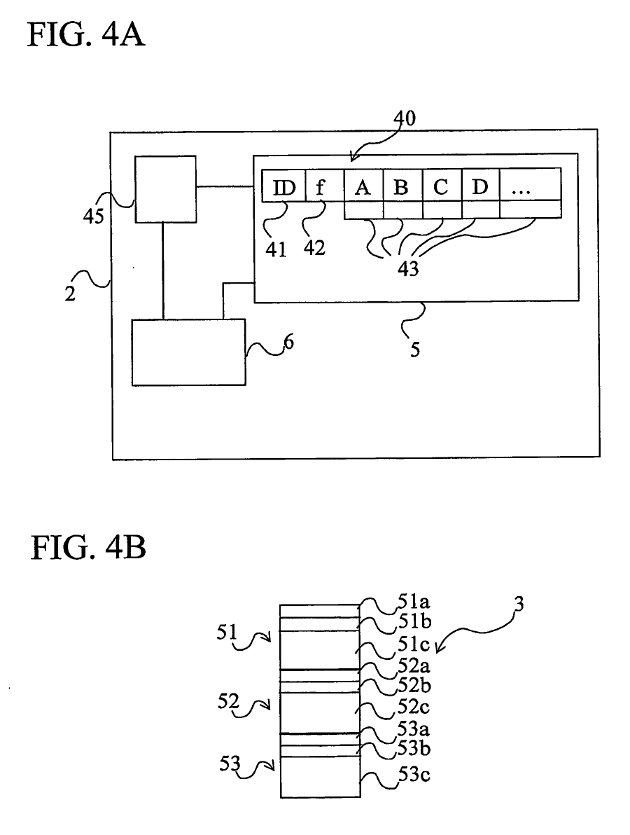

It should also be noted that other arrangements of the symbol groups are possible or other number of symbols may be included in each group. For example a 2×2 symbol group or a 3×1 symbol group may be used. Also, the symbols within a group may be differently related to each other. For example, a diagonal arrangement of the symbols may be contemplated. As a further alternative, a font definition is formed containing only the four unique individual symbols. Referring now to FIGS. 4A-4B, a general description of how fonts are handled by a printer will be given. As shown in FIG. 4A, a font 40 is stored in cache memory 5. When a character is to be printed, the font 40 is called to get image data for printing the character. If the character has not been printed before, the image data has not been created. Then instructions 42 from the font 40 are sent to a raster image processor 45 for creating a bitmap of the character. The bitmap 43 is then stored in the font 40 for the corresponding character such that it may be directly retrieved the next time the font 40 is called.

The font 40 is transferred to the printer 2 as instructions for creating bitmaps of the respective characters. The printer processor 6 sets the font 40 to be used as the current font and thus maintains a pointer to the font 40. The font 40 may also have an identifier 41 which enables the processor 6 to access the font 40 at a later time. If an identifier 41 is used, the processor 6 will first check whether the font 40 is already stored in cache memory 5. If stored, the font 40 is accessed by setting the font 40 as the current font and the font definition transferred to the printer 2 may be ignored. However, the identifier needs to be unique to avoid the processor 6 from retrieving a false font from the cache memory 5.

As illustrated in FIG. 4B, each page 51, 52, 53 of a printing job 3 typically comprises sufficient information to print the page individually. Thus, each page comprises a font definition 51a, 52a, 53a, and page-describing code 51c, 52c, 53c describing the page as a character-based representation using the font definition. When printing each page, the printer will check whether a font definition may be retrieved from cache memory. Otherwise the font definition is stored in cache memory and set as the current font as described above. By using identical definition identifiers 51b, 52b, 53b for the font definition 51a, 52a, 53a, it is assured that the font definition is only stored in cache memory when printing the first page and thereafter retrieved from cache memory when printing each subsequent page.

Now, the generation of definition identifiers for identifying font definitions of coding patterns will be described.

As noted above, the graphical representation of components of a coding pattern may be varied in a vast number of different ways depending on e.g. a magnitude of displacement of a mark with respect to its associated spatial reference point, a radius of the mark, and the grid spacing. The appropriate parameters to be used for printing a coding pattern will thus decide the font to be used. The font is labelled by an identifier which enables a printer to store the font in a cache memory and later retrieve and reuse the stored font.

The identifier of the font is generated when a printing job is to be made. This implies that a user may freely choose parameters of the coding pattern and is not limited to any fonts produced in beforehand. Still the printer will be able to store and reuse the font. The identifier eliminates the risk of a cache memory in a printer being filled during a single printing job. The same identifier is used throughout the printing job such that, even if the font is defined at the beginning of each page in the printing job, the font is only stored once in cache memory. Also, the use of the identifier reduces the speed of filling the cache memory.

According to one embodiment, the identifier is generated to be specific for the printing job to be made. This is an easy way of ascertaining that a cache memory of a printer will not be filled during printing of a document comprising a large number of pages. Using the PostScript language, the identifier may be defined as an extended unique identifier (XUID). A first part of the XUID is a number that identifies the organization that created the font. This number will be predefined and may be delivered with software for designing pages of coding pattern to be printed. The number will thus identify the distributor of the coding pattern. A second part of the XUID may be a random number that is retrieved or generated in connection with creating the page-describing code. Alternatively, the second part may be a counter value that represents the number of times a font definition has been used to print a coding pattern on the printer. Thus, this value may be incremented by one for each new printing job.

This approach of generating an identifier makes it unlikely that the generated identifier will be equal to an identifier previously used by the printer and thus stored in its cache memory. Therefore, there is a very small likelihood of false hits, which may otherwise render an incorrect printing as an incorrect font will be used in interpreting the page-describing code. Also, using the XUID, the risk of false hits corresponding to fonts created by other organizations is completely eliminated. However, if this risk is accepted, the identifier may instead be defined as a unique identifier (UID) using only a random number as the UID.

According to another embodiment, the identifier is generated in such a way that a font may be reused by a printer for different printing jobs. To this end, the identifier is generated to be specific to the morphology of the coding pattern. This morphology will define the font. By making the identifier specific to the morphology, the identifier may be created in such a way that the same font will always be defined by the same identifier. This implies that when the font has previously been used on the printer, the font is already stored in the cache memory with an identifier that exactly matches the identifier of the font in a later printing job. This will be acknowledged by the printer, which will be able to reuse the previously stored font and therefore not fill the cache memory.

One way of assuring that the same font is always defined by the same identifier is to use a number that is created on basis of parameters defining the morphology of the coding pattern. These parameters may be used in a number of different ways to create the number. For example, the number may be a hash value created on basis of the parameters. This assures that the same font is always defined by the same identifier. However, there is a small risk that two different fonts may generate the same identifier. The number of the identifier may alternatively be a sequence of absolute values of the parameters. If all critical parameters for uniquely defining the font are used, such an identifier does not risk any false hits. Using this sequence of absolute values of the parameters in an XUID will guarantee that the identifier will not be confused with any identifier of a different font.

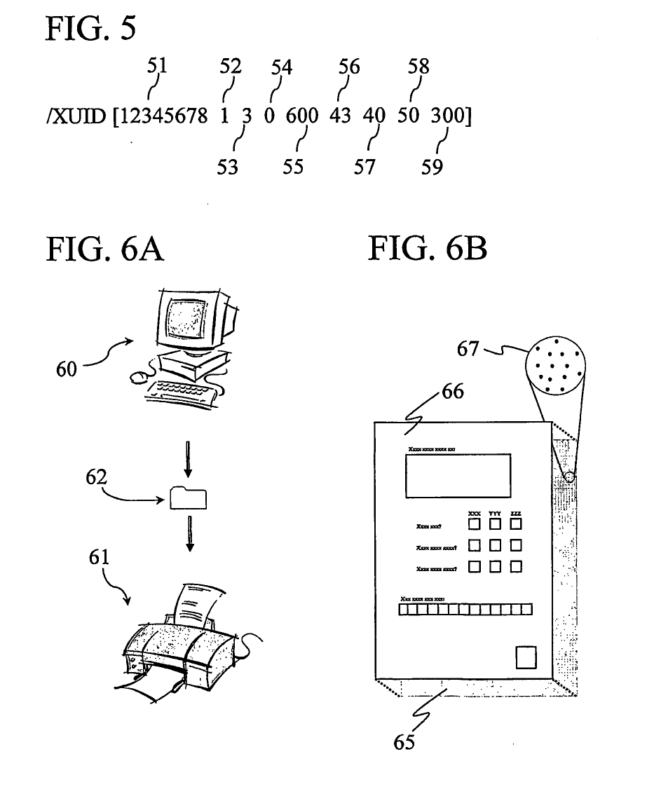

Referring to FIG. 5, an example of an XUID will be described. The XUID is a sequence of numbers 51-59. The first number 51 is a number that identifies the organization that created the font. This number will be predefined and may be delivered with software for designing pages of coding pattern to be printed. The number 51 will thus identify the distributor of the coding pattern. The second number 52 is a revision number and is also predefined. It indicates how many times a change has been made to the set of parameters to be used in the identifier. This predefined number 52 will assure that if the distributor decides to change which parameters are used to define a font, there is no risk that fonts specified by old parameters will interfere with fonts specified by new parameters. The third number 53 is the number of code symbols represented by a character in the font definition (e.g. 3 when defining 1×3 symbol groups in the font). The fourth number 54 is a value indicating a positioning of the mark in relation to a pixel coordinate describing the position of the mark (e.g. 0 when the mark is centred on the centre of a pixel or 1 when the mark is centred on a pixel coordinate, which typically defines the lower left corner of a pixel). Changing this value will affect which adjacent pixels a printer will use in order to draw the mark, as is further described in WO 2005/078569. The fifth number 55 is a measure of the resolution of a printer that is to print the coding pattern (e.g. 600 dots per inch). The sixth number 56 is a magnitude of displacement of said code mark with respect to its associated spatial reference point (e.g. 43 μm). The seventh number 57 is a radius of the mark (e.g. 40 μm). The eighth number 58 is an alternative radius of the mark (e.g. 50 nm). This alternative radius may be used when the coding pattern comprises two different sizes of the marks to encode further information into the coding pattern based on big/small marks. The alternative radius may also be used for handling influence from graphical data to be printed together with the coding pattern. Such graphical data may cause the marks to be printed with a smaller size, which may be accounted for by printing the marks with an alternative radius in areas that comprise such graphical data. The ninth and final number 59 is a distance between adjacent spatial reference points (e.g. 300 μm).

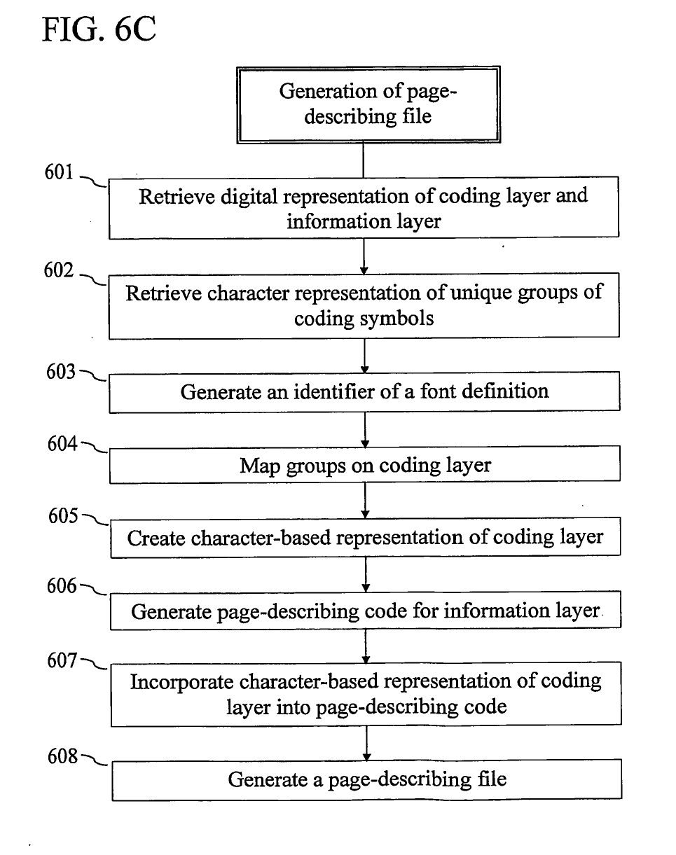

A system for printing a coding pattern is shown in FIG. 6A. The system includes a computer 60 and a printer 61. The printer 61 may be communicatively connected to the computer 60, so that a page-describing file 62 can be output for transfer from the computer 60 to the printer 61.

The computer 60 has access to a digital representation of the coding pattern which is to be applied as a machine-readable coding layer on a base, for example a sheet of paper. The computer system may also have access to a digital representation of graphical data which is to be printed as a human-readable information layer on the same base. The graphical data may include text, drawings, rulings, images, etc, typically to guide or inform the user of the coded base. FIG. 6B illustrates a combination of such a coding layer 65 and information layer 66, including an enlarged view of the coding pattern 67. As will be further described below, the computer 60 is capable of generating a page-describing code of the coding layer 65 and the information layer 66, if present. The coding layer 65 is defined by means of a font as described above. Alternatively, parameters of the coding pattern are included in the page-describing file for enabling a printer to generate the font. It is here assumed that the page-describing code is text-based and written in the widely adopted PostScript (trademark) programming language, although other types of formats and programming languages are certainly conceivable, for example PCL (Printer Control Language).

The printer 61 receives the page-describing file 62. The printer 61 contains a print file interpreter that analyses the file 62 and puts the file in a format ready for printing. When the page-describing file 62 contains parameters of the coding pattern, the print file interpreter will use these parameters to create a font definition and an identifier of the font. The print file interpreter will check the identifier of the font definition, either received in the page-describing file or created by the printer, to determine whether the font definition is present in a cache memory of the printer. If present, the font definition in the cache memory is set as the current font and no further handling of the font definition is needed. If the font definition is not present in the cache memory, the font definition will be stored with its identifier. Generally, the creation of bitmaps for each character in the font definition is not initially made.

The print file interpreter then reads the page-describing code in the page-describing file 62 and converts it to adequate printing instructions. Each font character is converted to a bitmap of the pattern to be printed. This is performed by retrieving a bitmap corresponding to the font character from the stored font definition. If no corresponding bitmap has yet been stored, the bitmap is created using printer instructions to build the bitmap and the bitmap is stored in the font definition. When the entire file has been properly converted, the printer 61 prints the document. Alternatively, the printer 61 may start printing concurrently with the conversion of the page-describing code, e.g. a page may be printed as soon as it has been properly converted. The operating principle of the printer can be based on any technology that produces either monochrome or polychrome printouts, including but not limited to ink jet, laser, dye-sublimation, solid ink, thermal wax, thermal autochrome, and dot matrix technology.

FIG. 6C illustrates principal steps of a method that may be executed in the computer 60 in the generation of the page-describing file 62 to be provided to the printer 61.

In step 601, a digital representation of the coding layer is retrieved, suitably from a memory associated with the computer 60. The digital representation of the coding layer 65 may be supplied to the computer 60 in pre-generated form, or be generated by the computer 60 on demand. For example, the digital representation may include the above-mentioned symbol values, with the mutual spatial arrangement between the symbols being retained. Similarly, step 601 may include retrieval of a digital representation of the information layer 66 to be printed.

Step 602 includes retrieving a font definition, in which a set of characters is defined to represent mutually unique groups of the symbols of the coding pattern. Some commonly used font definitions may be pre-defined. However, the font definition may alternatively be generated for a specific printing job, and may later be transferred to the printer together with the page-describing code.

Each group of symbols defines a combination of symbol values with a given spatial arrangement. The symbols of a group need not be mutually adjacent, but can have any spatial interrelation as long as this interrelation is commensurate with the spatial arrangement of symbols in the coding pattern, e.g. the regular grid arrangement of FIG. 2, which need not be either equidistant or orthogonal.

In step 603, an identifier of the font definition is generated. As described above, the identifier may be generated to identify the font definition in the specific printing job. Alternatively, the identifier may be generated to indicate the morphology of the coding pattern. The identifier will thus be stored in cache memory of a printer such that it may be accessed and reused in later printing jobs. According to one embodiment, the identifier is generated as an XUID, wherein a first part of the XUID is supplied to the computer 60 as a predetermined number and the second part is generated in dependence of the retrieved font definition.

In step 604, the digital representation of the coding layer is parsed based on the font definition. More specifically, the different groups of symbols included in the font definition are mapped against the digital representation. For every match, the corresponding character is stored in a data structure to represent its corresponding group of symbols. Thus, in step 605, a character-based representation of the coding layer is created, in which each character represents a given combination of code symbols with a given spatial arrangement.

In step 606, a page-describing code is generated for the information layer. This step may be implemented according to prior art technique, known to the person skilled in the art.

In step 607, the character-based representation of the coding layer is incorporated into the) page-describing code, to generate the final page-describing code for the information layer and the coding layer.

Steps 606 and 607 may alternatively be executed before or concurrent with the generation of the character-based representation (steps 604-605). Further, step 607 may be executed before or concurrent with step 606. Still further, step 606 may be excluded altogether, in the absence of any information layer.

In step 608, a page-describing file 62 is compiled. The page-describing file 62 includes the font definition and its identifier and the page-describing code. The page-describing file may be transferred to the printer 61 to cause the printer 61 to print the document. The printer 61 thus handles the page-describing file 62 in an appropriate way for printing as described above with reference to FIG. 4B.

The above generation of the page-describing file is suitably carried out by a processing unit of the computer 60 under control of a computer program, which may be embodied on a record medium, stored in a computer memory, embodied in a read-only memory or carried on an electrical carrier signal. The computer 60 further comprises a communication unit for transferring the page-describing file to the printer 61. The communication unit may be any unit that may transfer information from the computer, e.g. USB, Firewire, IrDA, Bluetooth, Ethernet, parallel port, modem.

The method is described above as performed by a computer for creating a page-describing file. It should however be noted that the identifier and/or font definition may be created in the printer. In such case, the page-describing file transferred to the printer may merely comprise the page-describing code and parameters defining the morphology of the coding pattern. A processor in the printer will then handle the parameters defining the morphology of the coding pattern in order to form the font definition and a definition identifier. A rasterized image is then formed based on the page-describing code, the font definition and the definition identifier. Printing of a page is then caused by sending the rasterized image to a print engine controller of the printer.

There are several different reasons why a single font definition may not be constantly used, which explain the need for allowing parameters of the coding pattern to be changed and font definitions to be formed and labelled with an identifier.

Firstly, an adaptation may be needed to printer characteristics of a specific printer. Two different printers do not print documents to be exact copies of each other. It is important that a coding pattern is accurately printed in order to be correctly interpreted. Therefore, each printer to be used may need to be set-up to properly print coding patterns. This is accomplished by setting parameters of the coding pattern to fit the printer characteristics. The proper parameters may be determined by empirically testing which parameters return the best result.

However, once the parameters of the coding pattern have been adapted to the printer to be used, there may still be a need to change the parameters over time and thus change the font definition to be used. For example, print quality of a printer varies as components of the printer age or wear. Also, the print quality is dependent of a quantity of ink in an ink supply of the printer, as described in US 2005/0052707. These temporal changes of the print quality may require changing the parameters of the coding pattern. Further, the print quality may be dependent on exterior parameters, such as humidity and temperature.

The printer may thus be able to sense such properties that affect printing quality. If such properties change, the font definition may need to be changed such that an unaltered hardcopy of the coding pattern is actually printed. This implies that a new font will need to be created. A computer may request the printer to provide information of the relevant properties before a font definition is created and a page-describing file is transferred to the printer. This information is then used in determining the proper font definition for obtaining a desired hardcopy of the coding pattern.

Alternatively, the printer may itself recognize changes to such properties, and in response thereto, the printer may create a new font definition to be used in printing. The printer may also be able to directly detect the print quality, e.g. by means of a sensor that analyses the actual parameters, such as dot size or shape, that have been printed. The printer may then adapt the font definition in response to the analysed result. If the print quality is detected to be unacceptable or a change in the properties is detected, the printer may temporarily interrupt a printing job in order to update the font definition and the rasterized image(s) before resuming printing of the printing job.

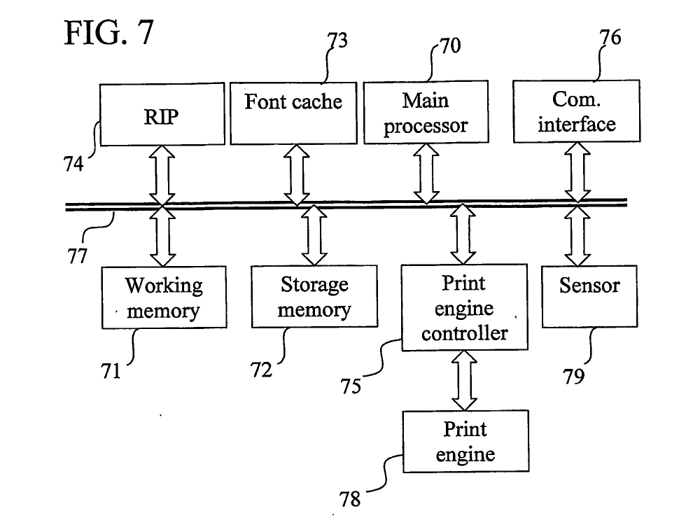

For the sake of completeness, FIG. 7 illustrates some main components of a conventional digital printer that may be used to print a coding pattern according to the invention. Such a digital printer may include a main processor 70 (e.g. CPU, microprocessor), a working memory 71 (e.g. RAM), a storage memory 72 (e.g. ROM, PROM, EEPROM, flash), a font cache memory 73, a raster image processor (RIP) 74, a print engine controller 75, and a communications interface 76 (e.g. USB, Firewire, IrDA, Bluetooth, Ethernet, parallel port, modem) which are inter-connected over a bus structure 77. The storage memory 72 holds the software for the main processor 70 and the RIP 74, as well as configuration data. When the main processor 70 receives the page-describing file via the communications interface 76, it operates the RIP 74 and uses the font cache memory 73 to convert the page-describing code into a rasterized image, which is stored in the working memory 71. Optionally, the page-describing file may be processed to generate the coding layer and the information layer in two separate images. The print engine controller 75 is then operated to retrieve the rasterized image(s) from the working memory 71 and control a print engine 78 to generate a hardcopy of the rasterized image(s). The printer may also comprise a sensor 79 for analysing the printing quality or detecting properties that affect the printing quality. The sensor 79 may give input to the processor 70 for creating an appropriate font definition or may provide information to a computer via the communications interface 76, such that the computer may account for the properties when designing a font definition.

The invention has mainly been described above with reference to a few embodiments. However, as is readily appreciated by a person skilled in the art, other embodiments than the ones disclosed above are equally possible within the scope and spirit of the invention, which is defined and limited only by the appended patent claims.

For example, the character definition set need not be a font definition. In an alternative embodiment, the character definition associates function/program calls, instead of font characters, with symbol groups. FIG. 3D shows a set of function/program calls that may represent the coding pattern in FIG. 2 in a page-describing file. Such a page-describing file would be based on a character definition in which each combination of blank space and a character represents printer instructions to generate a unique 1×3 symbol group. It could be noted that “_!” is used to represent the symbol group _r_d_l instead of “_n”, which has predefined meaning (new line) in the PostScript language. It should be noticed that the page-describing file may include instructions for the printer to store the results of the function/program calls in cache memory, to thereby increase the processing speed of the printer. Thus, instead of executing each call, the printer may simply retrieve the corresponding result from the cache memory.

Further, it should be noted that the coding pattern may be constructed in several other ways. Generally speaking, the above methodology may be useful to expedite on-demand printing in conventional printers of all coding patterns that are made up of a finite set of recurring symbol groups. Thus, the above coding pattern is only given for purposes of illustration. In this as well as other relevant coding patterns, the code symbols may have a finite number of predetermined, discriminable graphical states, each such state yielding a coding value of the symbol. The graphical states may be represented by a magnitude of displacement of a code mark with respect to an associated spatial reference point, a direction of displacement of a code mark with respect to an associated spatial reference point, a shape of a code mark, a size (diameter, surface area, etc) of a code mark, a color (hue, greyscale, texture, etc) of a code mark, or any combination thereof. For example, the coding pattern may consist of two differently sized code marks, whereby the size of code mark may encode one bit of information. The coding pattern is further described in aforesaid WO 00/73983, which is incorporated herein by this reference. Also, the code marks may be both displaced as described with reference to FIG. 2 and comprise different sizes. This pattern is described in detail in US Patent Publication No. 2003/0066896, which is incorporated herein by this reference.

Other examples of coding patterns are described in US 2005/0173544; US 2005/0147299; U.S. Pat. No. 6,076,738; U.S. Pat. No. 6,000,613; U.S. Pat. No. 5,245,165; and U.S. Pat. No. 5,221,833.

Moreover, other parameters of the morphology of the coding pattern may be conceived to handle the coding pattern of FIG. 2 or other coding patterns. Such other parameters may be e.g. shape of a code mark, colour of a code mark, geometry of the grouping of code marks. (vertical, horizontal, diagonal, angled, etc.), angular rotation of code mark, surface area of code mark, number of marks per symbol.

It should be noted that although it has been described above that the code symbols of the coding pattern will code a position or other data, the coding pattern may merely code information of reference positions.

Also, it has been described above that the printer may be able to generate a font definition and a definition identifier based on input of parameters defining the morphology of the coding pattern. However, the printer itself may have a database containing information on the coding pattern. The printer may thus be able to retrieve a digital representation of the coding layer to be printed from an internal memory. The printer would thus be able to generate the page-describing code itself using the coding layer, a generated font definition and a generated definition identifier. The page-describing code may thus be printed on demand, wherein an information layer may or may not be transferred to the printer.

1-39. (canceled)

40. A method in printing a coding pattern consisting of code symbols, comprising:
obtaining a character-based representation of the coding pattern, in which the code symbols are represented by characters according to a character definition set;
generating a definition identifier which identifies the character definition set and is specific to the morphology of the coding pattern to be printed; and
causing a print module to print said coding pattern based on said character- based representation, said character definition set, and said definition identifier,
wherein said generating is performed in connection to printing of the coding pattern.

41. The method according to claim 40, wherein the definition identifier comprises a number that is created on basis of parameters defining the morphology of the coding pattern.

42. The method according to claim 41, wherein said number is a hash value created on basis of said parameters.

43. The method according to claim 41, wherein said number is a sequence of absolute values of said parameters.

44. The method according to claim 41, wherein each code symbol of the coding pattern comprises a code mark and an associated spatial reference point, wherein said parameters are selected from the group consisting of:
a number of code symbols represented by a character in the character definition set;
a value indicating a positioning of the code mark in relation to a coordinate describing the position of the code mark;
a magnitude of displacement of said code mark with respect to its associated spatial reference point;
a size of said code mark;
an alternative size of said code mark;
a distance between adjacent spatial reference points;
and any combination thereof.

45. The method according to claim 40, wherein the generating of the definition identifier comprises defining a part of the definition identifier by a predetermined number provided by a distributor of the coding pattern.

46. The method according to claim 40, wherein said obtaining of a character-based representation comprises obtaining a font definition.

47. The method according to claim 46, wherein said font definition defines an outline font.

48. The method according to claim 46, wherein said font definition defines a bitmap font.

49. The method according to claim 40, wherein said character definition set assigns a set of first characters to represent mutually unique groups of code symbols and a set of second characters to represent each unique individual code symbol in the coding pattern, wherein at least one code symbol is represented in the character-based representation by its corresponding second character, if the number of symbols in one dimension of the coding pattern to be printed and the number of code symbols in a corresponding dimension of said groups are found to be relative prime.

50. The method according to claim 40, comprising retrieving a digital representation of said coding pattern, wherein each code symbol is represented by a respective coding value in said digital representation.

51. The method according to claim 50, wherein a plurality of said coding values together code a position.

52. The method according to claim 50, wherein each coding value contributes in the coding of a plurality of positions.

53. The method according to claim 50, wherein each coding value represents a predetermined, discriminable graphical state of said code symbol.

54. The method according to claim 53, wherein each code symbol comprises a code mark and an associated spatial reference point, wherein said states are represented by characteristics selected from the group consisting of:
a magnitude of displacement of said code mark with respect to its associated spatial reference point;
a direction of displacement of said code mark with respect to its associated spatial reference point;
a shape of said code mark;
a size of said code mark;
a color of said code mark;
and any combination thereof.

55. The method according to claim 54, wherein said spatial reference points are regularly spaced in said coding pattern.

56. The method according to claim 40, wherein said method is executed in a computer, and wherein said causing of a print module to print said coding pattern comprises transferring a page-describing file comprising said character-based representation, said character definition set, and said definition identifier to a printer comprising the print module.

57. The method according to claim 56, wherein said page-describing file is generated as a text file, preferably a Postscript file or a Printer Control Language (PCL) file.

58. The method according to claim 57, wherein the page-describing file is generated as a Postscript file and the identifier is generated as an extended unique identifier (XUID).

59. The method according to claim 40, wherein said method is executed in a printer, said printer being arranged to receive morphological pattern parameters for specifying the character definition set and generating the definition identifier.

60. The method according to claim 59, further comprising sensing properties affecting printing quality, wherein the printer in response to a detected change of said properties determines altered morphological pattern parameters that leaves a printed hardcopy of the coding pattern unaltered by said change of properties, specifies an updated character definition set and generates a definition identifier of the updated character definition set using the altered morphological pattern parameters.

61. A computer program product, directly loadable into the internal memory of a processor in a computer unit, comprising software instructions that, when executed in said processor, perform the method according to claim 40.

62. A system for printing a coding pattern consisting of code symbols, comprising:
means for obtaining a character-based representation of the coding pattern, in which the code symbols are represented by characters according to a character definition set;
means for generating a definition identifier which identifies the character definition set and is specific to the morphology of the coding pattern to be printed; and
means for causing a print module to print said coding pattern based on said character-based representation, said character definition set, and said definition identifier.

63. The system according to claim 62, wherein the means for generating a definition identifier is arranged to generate a definition identifier that comprises a number that is created on basis of parameters defining the morphology of the coding pattern.

64. The system according to claim 63, wherein said number is a hash value created on basis of said parameters.

65. The system according to claim 63, wherein said number is a sequence of absolute values of said parameters.

66. The system according to claim 62, wherein said means for obtaining a character-based representation of the coding pattern and said means for generating a definition identifier are implemented as a processing unit of a computer, and wherein said means for causing of a print module to print said coding pattern is implemented as a communication unit of said computer for transferring a page-describing file comprising said character-based representation, said character definition set, and said definition identifier to a printer comprising the print module.

67. The system according to claim 62, wherein said means for obtaining a character-based representation of the coding pattern, said means for generating a definition identifier, and said means for causing of a print module to print said coding pattern are implemented as a processing unit of a printer that controls a raster image processor and a print engine controller.

68. A method in printing a coding pattern consisting of code symbols, comprising:
obtaining a character-based representation of the coding pattern, in which the code symbols are represented by characters according to a character definition set;
generating a definition identifier which identifies the character definition set and is specific to the printing job to be made; and
causing a print module to print said coding pattern based on said character- based representation, said character definition set, and said definition identifier.

69. The method according to claim 68, wherein the generating of the definition identifier comprises retrieving a random number.

70. The method according to claim 68, wherein the generating of the definition identifier comprises retrieving a value representing the number of times a printing job of printing a coding pattern has been made by a specific print module.

71. The method according to claim 68, wherein the generating of the definition identifier comprises defining a part of the identifier by a predetermined number provided by a distributor of the coding pattern.

72. A computer program product, directly loadable into the internal memory of a processor in a computer unit, comprising software instructions that, when executed in said processor, perform the method according to claim 68.

73. A system for printing a coding pattern consisting of code symbols, comprising:
means for obtaining a character-based representation of the coding pattern, in which the code symbols are represented by characters according to a character definition set;
means for generating a definition identifier which identifies the character definition set and is specific to the printing job to be made; and
means for causing a print module to print said coding pattern based on said character-based representation, said character definition set, and said definition identifier.

74. The system according to claim 73, wherein the means for generating a definition identifier is arranged to retrieve a random number.

75. The system according to claim 73, wherein the means for generating a definition identifier is arranged to retrieve a value representing the number of times a printing job of printing a coding pattern has been made by a specific print module.

76. The system according to claim 73, wherein the means for generating a definition identifier is arranged to define a part of the identifier by a predetermined number provided by a distributor of the coding pattern.

77. The system according to claim 73, wherein said means for obtaining a character-based representation of the coding pattern and said means for generating a definition identifier are implemented as a processing unit of a computer, and wherein said means for causing of a print module to print said coding pattern is implemented as a communication unit of said computer for transferring a page-describing file comprising said character-based representation, said character definition set, and said definition identifier to a printer comprising the print module.

78. The system according to claim 73, wherein said means for obtaining a character-based representation of the coding pattern, said means for generating a definition identifier, and said means for causing of a print module to print said coding pattern are implemented as a processing unit of a printer that controls a raster image processor and a print engine controller.
